(19) United States
(12) Patent Application Publication
(10) Pub. No.: US 2025/0153588 A1
(43) Pub. Date: May 15, 2025

(54) PLUG-IN CONNECTOR PART FOR A CHARGING SYSTEM FOR CHARGING AN ELECTRIC VEHICLE

(71) Applicant: PHOENIX CONTACT E-Mobility GmbH, Schieder-Schwalenberg (DE)

(72) Inventor: Thomas Fuehrer, Blomberg (DE)

(21) Appl. No.: 18/836,780

(22) PCT Filed: Feb. 2, 2023
(86) PCT No.: PCT/EP2023/052535

§ 371 Date: Aug. 8, 2024

(30) Foreign Application Priority Data
Feb. 11, 2022 (BE) BE2022/5091

(51) Int. Cl. B60L 53/302; B60L 53/16; H01R 13/533

(52) U.S. Cl. CPC B60L 53/302; B60L 53/16; H01R 13/533; H01R 2201/26

(57) ABSTRACT

A connector part for a charging system for charging an electric vehicle includes: a plug-in portion for plugging connection to a mating connector part; at least one electric plug contact disposed on the plug-in portion so as to transmit a charging current; at least one busbar electrically connected to the at least one plug contact, the at least one busbar being connectable to a load conductor and having a face portion extending flat along a plane; and a cooling unit having a housing disposed on the face portion for conducting a coolant flow, the housing being open at a side facing the face portion, an electrically insulating separating layer being disposed between the housing and the face portion, the face portion being disposed on a first side of the separating layer so as to flow the coolant flow on a second side of the separating layer.

### CROSS-REFERENCE TO PRIOR APPLICATIONS

This application is a U.S. National Phase application under 35 U.S.C. § 371 of International Application No. PCT/EP2023/052535, filed on Feb. 2, 2023, and claims benefit to Belgian Patent Application No. BE 2022/5091, filed on Feb. 11, 2022. The International Application was published in German on Aug. 17, 2023 as WO/2023/152018 under PCT Article 21 (2).

### FIELD

The invention relates to a connector part for a charging system for charging an electric vehicle and to a charging system for charging an electric vehicle.

### BACKGROUND

Such a connector part includes a plug-in portion for plugging connection to a mating connector part, at least one plug contact disposed on the plug-in portion and adapted for transmitting a charging current, and at least one busbar, which is electrically connected to the at least one plug contact, is connectable to a load conductor, and has a face portion extending flat along a plane.

Such a connector part may be configured as a charging plug or a charging socket and disposed on a charging cable of a charging station or on an electric vehicle. A charging socket can be used to connect a charging plug disposed on a charging cable so as to establish an electrical connection between a charging station and the electric vehicle and to electrically charge the electric vehicle.

In the field of e-mobility, it is desirable to charge electric vehicles quickly and efficiently in order to reduce charging times and associated travel interruption times. In order to enable fast charging of an electric vehicle during a fast-charge operation, high charging rates are used, which are associated with high charging currents, for example, with an amperage of 700 A or even higher. For charging commercial vehicles, even amperages up to 3000 A are conceivable.

When transmitting high charging currents, the contact elements and other components of the connector part heat up. In accordance with applicable provisions, the heating-up of a connector part must not exceed 50 K. Therefore, if high charging currents are used, care must be taken to prevent excessive heating of the connector part.

The arrangement and dimensioning of electrical contact elements on connector parts for charging an electric vehicle is usually defined by standards. Therefore, contact geometries of such connector parts cannot be readily scaled in order to possibly achieve a greater current-carrying capacity of the contact elements. One challenge, therefore, is to allow for maximum possible power transfer with existing contact geometries.

The current-carrying capacity of, for example, a charging cable and a charging plug connected to the charging cable can, in principle, be increased by enlarging the cross section of the current-carrying load conductors. However, since a charging cable has to be handled manually by a user, there are limits to increasing the cross section of the load conductors and the associated weight increase of the charging cable.

One way to enhance the current-carrying capacity of the charging cable, of the charging plug, and of the charging socket is to provide active cooling of the current-carrying components, in particular of the charging cable and of the charging plug connected to the charging cable. If water or a water mixture (containing, for example, antifreeze) is used as the cooling medium, care must be taken to ensure that the cooling medium does not come into contact with current-carrying components. If water should come into contact with DC-carrying components, there would be a risk of the water being electrolytically decomposed, which could lead to damage to the components. In addition, contact of water with current-carrying components must always be ruled out to avoid an electrical hazard.

In a charging plug known from EP 3 103 173 B1, a cooling unit is disposed between busbar components, through which a coolant can be flowed. In a housing of the cooling unit, a flow path is defined and configured to guide the coolant flow tangentially along the busbar components.

In a connector part known from DE 10 2016 107 409 A1, a coolant is flowed through cooling bodies. The cooling bodies are connected via thermal conductors to associated contact elements in order to absorb heat from the contact elements through the thermal conductors.

### SUMMARY

In an embodiment, the present invention provides a connector part for a charging system for charging an electric vehicle, the connector part comprising: a plug-in portion for plugging connection to a mating connector part; at least one electric plug contact disposed on the plug-in portion and configured to transmit a charging current; at least one busbar electrically connected to the at least one plug contact, the at least one busbar being connectable to a load conductor and having a face portion extending flat along a plane; and a cooling unit having a housing disposed on the face portion and being configured to conduct a coolant flow, the housing being open at a side facing the face portion, an electrically insulating separating layer being disposed between the housing and the face portion, the face portion being disposed on a first side of the separating layer so as to flow the coolant flow on a second side of the separating layer.

### BRIEF DESCRIPTION OF THE DRAWINGS

The present invention will be described in even greater detail below based on the exemplary figures. The invention is not limited to the exemplary embodiments. Other features and advantages of various embodiments of the present invention will become apparent by reading the following detailed description with reference to the attached drawings which illustrate the following:

FIG. 1 is a view of a charging station with an attached charging cable for connection to an electric vehicle;

FIG. 2 is a view of an exemplary embodiment of a connector part in the form of a charging plug;

FIG. 3A is a view showing the connector part without a housing;

FIG. 3B is another view of the assembly shown in FIG. 3A;

FIG. 4A is a view showing an arrangement of plug contacts of the connector part, with a cooling unit disposed between busbars of the plug contacts;

FIG. 4B is another view of the arrangement of FIG. 4A;

FIG. 5A is a side view of the arrangement of FIG. 4A;

FIG. 5B is a top view of the arrangement of FIG. 4A;

FIG. 6A is an exploded view of the arrangement of FIG. 4A;

FIG. 6B shows the exploded view from a different perspective;

FIG. 7A is a partially exposed view of the arrangement of FIG. 4A;

FIG. 7B is another view of the arrangement of FIG. 7A;

FIG. 8A is a sectional view taken along line I-I in FIG. 7B;

FIG. 8B is a sectional view taken along line II-II in FIG. 7B;

FIG. 8C is an enlarged view of the detail A of FIG. 8A;

FIG. 9 is a view of the arrangement of FIG. 5B, illustrating a coolant flow through the cooling unit;

FIG. 10A is an enlargement of a portion of the sectional view of FIG. 8A, illustrating a coolant flow through chambers of a chamber array of the cooling unit;

FIG. 10B is an enlarged partial view of the arrangement of FIG. 8A, illustrating a coolant flow through chambers of the chamber array of the cooling unit;

FIG. 11 is a partial exploded view of another exemplary embodiment of a contact assembly of a connector part;

FIG. 12 is a view of a cooling unit of the contact assembly;

FIG. 13 is a side view of the cooling unit;

FIG. 14A is a sectional view taken along line I-I in FIG. 13;

FIG. 14B is a sectional view taken along line II-II in FIG. 13;

FIG. 15 is an enlarged sectional exploded view of the detail A of FIG. 14A;

FIG. 16 is another enlarged sectional view showing the detail B of FIG. 14A;

FIG. 17 is an enlarged sectional view similar to the view of FIG. 15, but showing the assembled state.

### DETAILED DESCRIPTION

In an embodiment, the present invention provides a connector part that enables cost-effective active cooling of current-carrying components, with efficient heat absorption from the current-carrying components and reliable electrical insulation of a coolant flow from the current-carrying components.

Accordingly, the connector part has a cooling unit which has a housing disposed on the face portion and adapted for conducting a coolant flow, the housing being open at a side facing the face portion, and an electrically insulating separating layer being disposed between the housing and the face portion, the face portion being disposed on a first side of the separating layer, and the coolant flow flowing on a second side of the separating layer.

The housing is open at a side facing the face portion. Thus, an interior of the housing is open toward the face portion, so that a coolant flow passing through the housing is guided at the face portion without a housing wall disposed therebetween, thus allowing heat to be absorbed from the face portion in an efficient manner.

If an electrically non-conductive fluid, for example an oil-based cooling medium, is used as the cooling medium, no special precautions need to be taken to electrically insulate the cooling medium from the face portion. In contrast, if water or another electrically conductive fluid is used as the cooling medium, it must be ensured that the face portion is electrically insulated from the cooling medium.

This is achieved in the present case by disposing an electrically insulating separating layer on the face portion, which separating layer provides electrical insulation between the face portion and the cooling medium in the housing. The separating layer covers the face portion of the busbar in such a way that the face portion is disposed on a first side of the separating layer, while the coolant flow flows on a second side of the separating layer in the housing. The coolant flow is in contact with the separating layer, so that the separating layer acts as a (direct) intermediate layer, separating the coolant flow from the face portion.

The separating layer is in contact with the face portion on the first side. The coolant flow, on the other hand, flows on the second side of the separating layer. Therefore, heat can pass from the face portion via the separating layer into the coolant flow and, thus, can be absorbed and removed by the coolant flow.

Since the separating layer can be made thin, the thermal resistance of the separating layer can be kept low, so that heat can be efficiently absorbed and removed by from the face portion of the busbar by the coolant flow.

The separating layer may, for example, be formed by a plastic film, in particular a film of a high-performance plastic, for example, a material containing polyimide, in particular polysuccinimide (PSI), polybismaleinimide (PBMI), polyimide sulfone (PISO), or polymethacrylimide (PMI), or other plastic material exhibiting similar performance characteristics. Preferably, the plastic film is not meltable (at temperatures occurring during operation of the connector part when used as intended) and provides electrical insulation with high dielectric strength, even with a small film thickness.

The plastic film may, for example, have a thickness equal to or less than 0.1 mm, preferably equal to or less than 0.07 mm, more preferably equal to or less than 0.03 mm. The fact that the separating layer has a small thickness (wall thickness) results in a low thermal resistance at the separating layer, so that heat can be efficiently absorbed from the busbar and removed via the cooling unit.

The plastic film, especially when made from a polyimide material, should have a high, permanent dielectric strength with respect to the electrical potential between the power contact and the coolant flow. The area-normalized thermal resistance of the separating layer is equal to the quotient of the thickness (wall thickness) of the separating layer and the specific thermal conductivity of the separating layer. Thus, in order to minimize thermal resistance, the wall thickness should be selected to be small and/or the thermal conductivity should be selected to be high. Because the thickness (wall thickness) of the separating layer can be very small when it is made of a plastic film, especially when it is made of a polyimide material, the thermal resistance at the separating layer can be low even if the specific thermal conductivity of the separating layer is only medium, for example on the order of 0.4 W/(mK).

The separating layer formed by a plastic film may, for example, be adhesively bonded or otherwise attached to the face portion of the busbar in order to ensure that the face portion is tightly covered by the separating layer over a continuous surface area thereof.

The separating layer may have additional functional layers disposed on the plastic film, for example vapor-deposited layers, in order to adapt the heat transfer and/or the dielectric strength to the intended application.

In one embodiment, the separating layer may be formed by a thermally conductive element made from a material different from the material of the housing. The housing may, for example, be made from a plastic material. The thermally conductive element, on the other hand, is made from a material different from the plastic material of the housing, for example, a material containing silicone rubber.

“Silicone rubber” refers to elastomers consisting of silicone polymer chains with alternately arranged, alternating oxygen and silicon atoms, i.e. —Si—O—Si bonds (siloxane bonds). Therefore, they are also referred to as polyorganosiloxanes.

If the separating layer is formed by a (flat) thermally conductive element, the thermally conductive element may, for example, have a thickness equal to or less than 1 mm, preferably equal to or less than 0.5 mm. Such a separating layer formed by a thermally conductive element can have a high specific thermal conductivity, for example up to 5 W/(mK). Such a thermally conductive element can thus have a low thermal contact resistance despite a relatively large wall thickness.

The thermally conductive element covers the face portion of the busbar over a continuous surface area thereof and is, for example, adhesively bonded thereto.

In one embodiment, the separating layer may be formed, for example, by an electrically insulating coating on the face portion, for example by a coat of varnish or a flock coating on the face portion.

The housing is disposed on the face portion of the busbar, for example screwed to the housing. The separating layer occupies an intermediate position between the housing and the face portion. In order to provide a fluid-tight junction between the housing and the separating layer, for example, a seal may be disposed between the housing and the separating layer, for example, a circumferential seal on the side of the housing facing the face portion, which seal creates a fluid-tight junction between the housing and the separating layer so as to prevent leakage of the cooling medium.

If the face portion of the busbar is flat, the separating layer for coving the face portion over a continuous surface area thereof is also flat. In contrast, if the face portion is curved, the separating layer is also curved. If the face portion is cylindrical, the separating layer may, for example, extend as a tubular section within the face portion or externally around the face portion.

In one embodiment, the cooling unit has a chamber array arranged in the housing and adapted for guiding a coolant flow. The chamber array includes a plurality of chambers in fluid communication with one another. At least some of the chambers are configured to guide a coolant flow along a flow direction perpendicular to the plane.

According to this embodiment, the cooling unit includes a housing having chambers formed therein through which a coolant flow is guided during operation so as to absorb heat from the busbar connected to the plug contact. The housing of the cooling unit is disposed on the face portion of the busbar, so that the coolant flow is guided through the housing and thereby at the face portion, thus allowing heat to be absorbed from the face portion in an advantageous manner. Via the coolant flow, the heat can be removed, and the busbar, and thus the electrical contact connected to the busbar, can be actively cooled.

The housing is disposed on the face portion of the busbar. Preferably, the housing is attached to the face portion, for example, adhesively bonded or screwed to the face portion.

The housing is preferably be made from an electrically insulating material, in particular a plastic material. In contrast, the busbar, including the face portion formed thereon, is composed of a material that has good electrical conductivity, in particular a metal material, for example a copper material.

The coolant flow is guided via the chamber array in such a way that it flows through at least some of the chambers along a flow direction perpendicular to the plane of the face portion. The coolant flow is thus directed by some of the chambers in the flow direction toward the face portion, and therefore impinges perpendicularly on the face portion. In contrast, other chambers direct the coolant flow away from the face portion against the flow direction. Because the coolant flow is directed perpendicularly at the face portion, it is possible to achieve that heat is absorbed from the face portion with a good heat transfer coefficient and thus with a high cooling efficiency, especially when compared to a coolant flow that is directed tangentially (parallel) to the face portion.

The plane may be flat. However, the plane may also be curved, so that the face portion of the busbar has a curved shape. For example, the busbar may be cylindrical in shape, and the face portion may correspond to a wall portion of the cylindrical busbar.

Advantageously, the chamber array is configured to guide the coolant flow in a meandering manner in the flow direction toward the face portion and away from the face portion against the flow direction. Thus, the coolant flow flows perpendicularly toward the face portion and also perpendicularly away from the face portion. Because the coolant flow is directed perpendicularly at the face portion at a plurality of points, heat can be absorbed from the busbar in a distributed manner over the surface area of the face portion and can thus be removed from the busbar in an advantageous and efficient manner.

If, in particular for purposes of transmitting a charging current in the form of a direct current, the connector part has two plug contacts, each connected to a respective busbar, then the housing may, for example, be disposed between the face portions, and may guide the coolant flow back and forth between the face portions in a meandering manner. Thus, the coolant flow is directed perpendicularly at the face portions of the busbars and, thus, can absorb heat from the face portions in an efficient manner.

In one embodiment, a first chamber of the chamber array is configured to guide the coolant flow in the flow direction toward the face portion. The first chamber may, for example, have a first flow cross section. The first chamber is adjoined, for example, by a first approach flow channel in the flow direction, which first approach flow channel serves to guide the coolant flow from the first chamber in the flow direction toward the face portion. The first approach flow channel preferably has a reduced flow cross section compared to the flow cross section of the first chamber, so that the coolant flow is conveyed in the approach flow channel with reduced flow cross section and, thus, at increased flow velocity toward the face portion of the busbar and impinges perpendicularly on the face portion of the busbar.

In one embodiment, a second chamber in fluid communication with the first chamber is configured to guide the coolant flow away from the face portion against the flow direction. The second chamber is disposed downstream of the first chamber and therefore receives the coolant flow from the first chamber. The second chamber guides the coolant flow away from the face portion of the busbar, for example toward a face portion of an adjacent busbar associated with another plug contact.

The second chamber may be adjoined by a second approach flow channel, which serves to guide the coolant flow from the second chamber against the flow direction, for example toward the face portion of the adjacent busbar. The second approach flow channel may also have a reduced flow cross section. The flow cross section of the second chamber may, for example, be equal to the flow cross section of the first chamber. The second approach flow channel, on the other hand, has a reduced flow cross section, which is, for example, equal to the flow cross section of the first approach flow channel.

The second chamber may be in fluid communication with a downstream third chamber, which is configured to guide the coolant flow (once again) in the flow direction toward the face portion of the busbar. The third chamber may be adjoined in the flow direction by a third approach flow channel, which guides the coolant flow with reduced flow cross section perpendicularly along the flow direction toward the face portion.

The third chamber may be adjoined by additional chambers that are arranged relative to one another and in fluid communication with one another in such a way that the coolant flow is guided toward the face portion and away from the face portion in a meandering manner such that the coolant flow impinges perpendicularly on the face portion at a plurality of points, thus allowing heat to be absorbed from the face portion in an advantageous and efficient manner.

The face portion extends along a plane defined by a longitudinal direction and a vertical direction. A transverse direction, which corresponds to a surface normal to the plane, is perpendicular to the longitudinal direction and the vertical direction. The chambers of the chamber array may all be offset from one another along the longitudinal direction and/or along the vertical direction and/or along the transverse direction, the chambers together forming a flow channel that guides the coolant flow perpendicularly toward the face portion and also perpendicularly away from the face portion, preferably in a meandering manner.

In one embodiment, the chambers are arranged in two height planes. A first array of chambers may be arranged in distributed relation along a first height plane which is perpendicular to the vertical direction. A second array of chambers, on the other hand, may be arranged in distributed relation along a second height plane which is perpendicular to the vertical direction and spaced apart from the first height plane. In each of the vertically offset arrays of chambers, the coolant flow is guided in a meandering manner. Once the coolant flow has passed through the chambers of one height plane, it enters the chambers of the other height plane and is guided through these chambers, again in a meandering manner.

Each array of chambers may have associated therewith a port for connection of a coolant conduit. In particular, the first array of chambers may have a first port for introducing the coolant flow, and the second array of chambers may have a second port for discharging the coolant flow.

The ports may each be connectable to a coolant hose. The coolant hoses may, for example, be routed together with the load conductors within a charging cable connected to the connector part. Via the charging cable, the connector part may be connected, for example, to a charging station.

In one embodiment, the connector part has two electrical plug contacts and two busbars, each busbar having a face portion and each being connected to one of the plug contacts. The cooling unit is disposed between the face portions of the busbars. The housing of the cooling unit is attached to the face portions, for example, adhesively bonded or screwed to the face portions. Via the chamber array in the housing of the cooling unit, a coolant flow is preferably guided back and forth between the face portions in a meandering manner so that the coolant flow is alternately directed perpendicularly at one face portion and at the other face portion, during which process it flows back and forth between the face portions. This allows heat to be efficiently absorbed from both face portions and removed from the face portions.

A charging system for charging an electric vehicle includes a connector part of the type described hereinabove. Such a charging system further includes a mating connector part capable of being connected to the connector part. The connector part may, for example, implement a charging plug mounted on a charging cable. The mating connector part, on the other hand, may, for example, be disposed as a charging socket on the electric vehicle and may be connectable to the connector part in the form of the charging plug. The charging plug may be connected via the charging cable to, for example, a charging station so that charging currents can be transmitted from the charging station to the electric vehicle when the plug connector part and the mating connector part are in the mated position.

However, it is also conceivable that the connector part may implement a charging socket on the electric vehicle.

A connector part of the type described herein can be used in particular for transmitting charging currents in the form of direct currents. However, such a connector part may also serve for transmitting charging currents in the form of alternating currents.

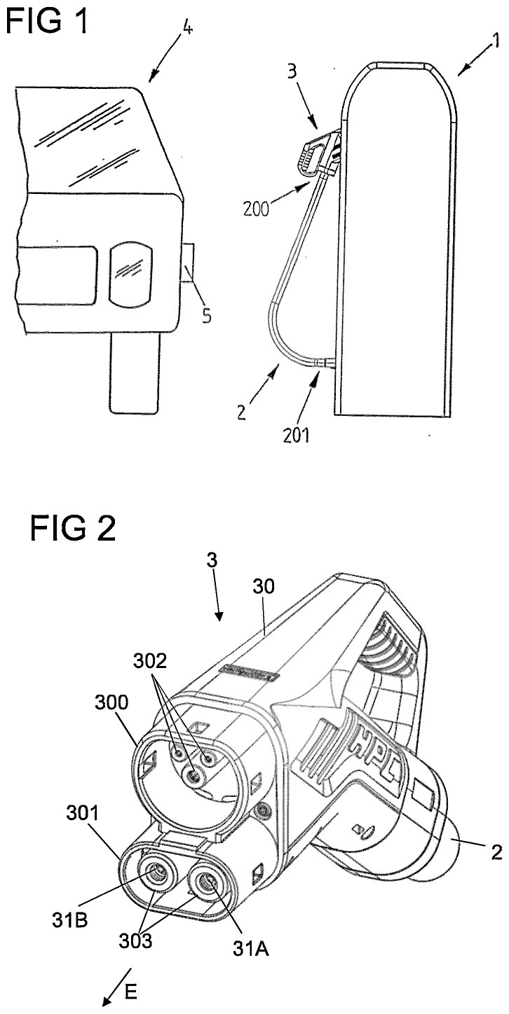

FIG. 1 shows a charging system including a charging station 1 that serves for charging an electrically powered vehicle 4, also referred to as an electric vehicle. Charging station 1 is configured to provide a charging current in the form of an alternating current or a direct current, and has a cable 2 that is connected at one end 201 to charging station 1, and at the other end 200 to a connector part 3 in the form of a charging plug.

As can be seen from the enlarged view of FIG. 2, connector part 3 has plug-in portions 300, 301 on a housing 30 thereof, by which plug-in portions 300, 301 plug connector part 3 can be pluggingly engaged with an associated mating connector part 5 in the form of a charging socket on vehicle 4. In this way, charging station 1 can be electrically connected to vehicle 4 in order to transmit charging currents from charging station 1 to vehicle 4.

In order to enable rapid charging of electric vehicle 4, for example, during what is known as a fast-charge operation, the charging currents transmitted may have a high amperage, for example, greater than 500 A, possibly even on the order of 700 A or higher. Charging currents of such high amperage levels cause thermal losses in cable 2 and also in charging plug 3, which can lead to heating of cable 2, of charging plug 3, and of charging socket 5.

The permissible heating of components in the charging system is limited by standards, for example to a maximum value of 50 K. Consequently, measures must be taken to prevent excessive heating during charging, especially when using high amperages, for example, on the order of 700 A or higher.

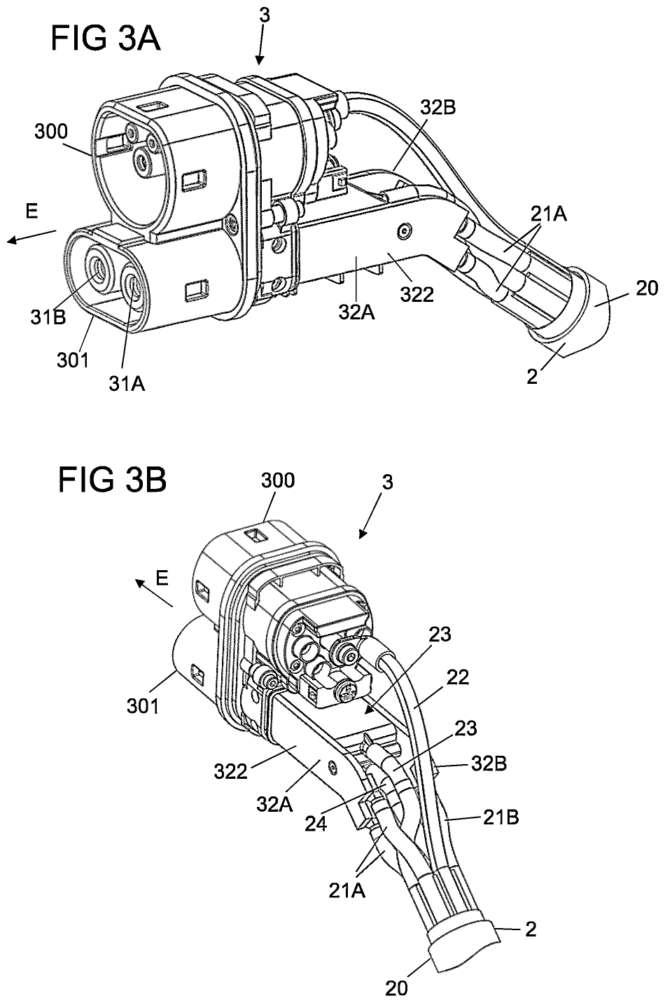

In the connector part 3 in the form of the charging plug shown in FIG. 2, plug contacts are disposed on the plug-in domes 302 in upper plug-in portion 300, which plug contacts are used, for example, for transmitting control signals or as a grounding contact (connected to a grounding conductor 22, see FIG. 3B). In lower plug-in portion 301, on the other hand, plug contacts 31A, 31B are disposed on plug-in domes 303, which plug contacts 31A, 31B are used as load contacts for transmitting a charging current in the form of a direct current. During mating with the associated mating connector part 5 in the form of the charging socket on electric vehicle 4, plug contacts 31A, 31B come into electrical contact with associated mating contact elements on charging socket 5, so that a charging current can be transmitted from charging station 1 to electric vehicle 4.

The illustrated connector part 3 in the form of the charging plug is provided with active cooling to absorb and remove heat, in particular in the region of the charging current-carrying plug contacts 31A, 31B, so as to limit heating of connector part 3.

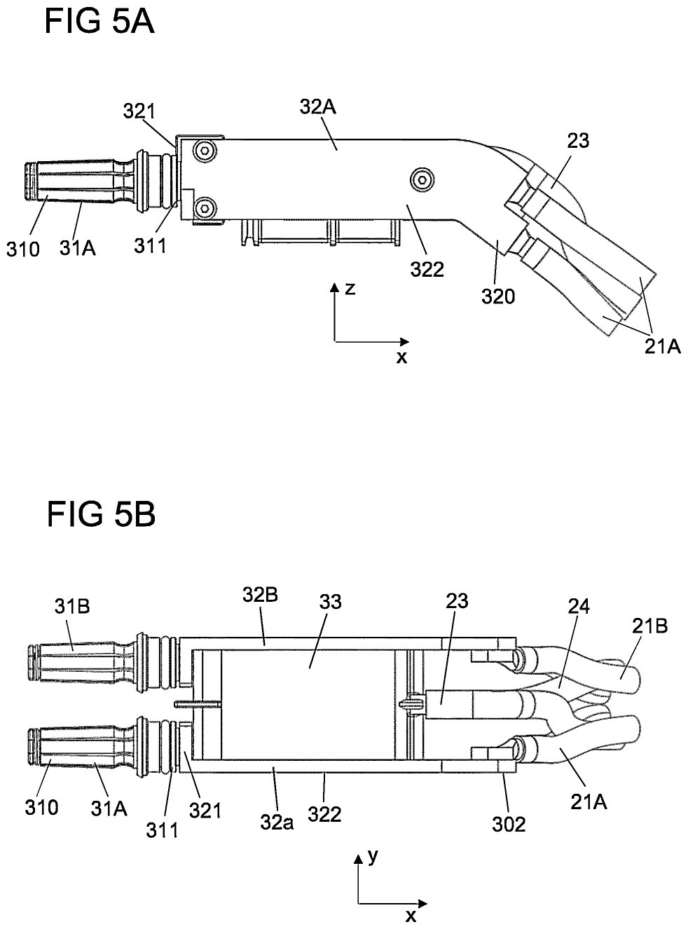

As can be seen from FIGS. 3A, 3B through 6A, 6B, in the illustrated embodiment of connector part 3, each plug contact 31A, 31B is associated with a busbar 32A, 32B, via which the respective plug contact 31A, 31B is connected to a respective arrangement of two load conductors 21A, 21B.

Each plug contact 31A, 31B has a contact portion 310 in the form of a socket, via which a mating connection with an associated mating contact element in the form of a contact pin of mating connector part 5 can be established. Plug contact 31A, 31B is connected at an end opposite to contact portion 310 to an associated, flange-shaped end 321 of the associated busbar 32A, 32B, so that plug contact 31A, 31B is mechanically fixed and electrically contacted to the respective busbar 32A, 32B via the associated, flange-shaped end 321.

At an end 320 end opposite to end 321, each busbar 32A, 32B is connected to an arrangement of load conductors 21A, 21B. Here, each busbar 32A, 32B is connected to two load conductors 21A, 21B, which are thus connected together to the respectively associated plug contact 31A, 31B and carry a charging current in the form of a direct current via plug contacts 31A, 31B.

Load conductors 21A, 21B are routed together within the charging cable 2 connected to connector part 3 and are enclosed in a cable jacket 20 of charging cable 2 (see, for example, FIGS. 3A, 3B).

Disposed between busbars 32A, 32B is a cooling unit 33, which is used to absorb and remove heat from busbars 32A, 32B. Each busbar 32A, 32B has a flat face portion 322. Face portions 322 of busbars 32A, 32B extend parallel to each other and are each fixedly connected via screw connections to a housing 330 of cooling unit 33, so that the busbars 32A, 32B are mechanically fixed to each other via cooling unit 33.

Housing 330 of cooling unit 33 is made from an electrically insulating plastic material.

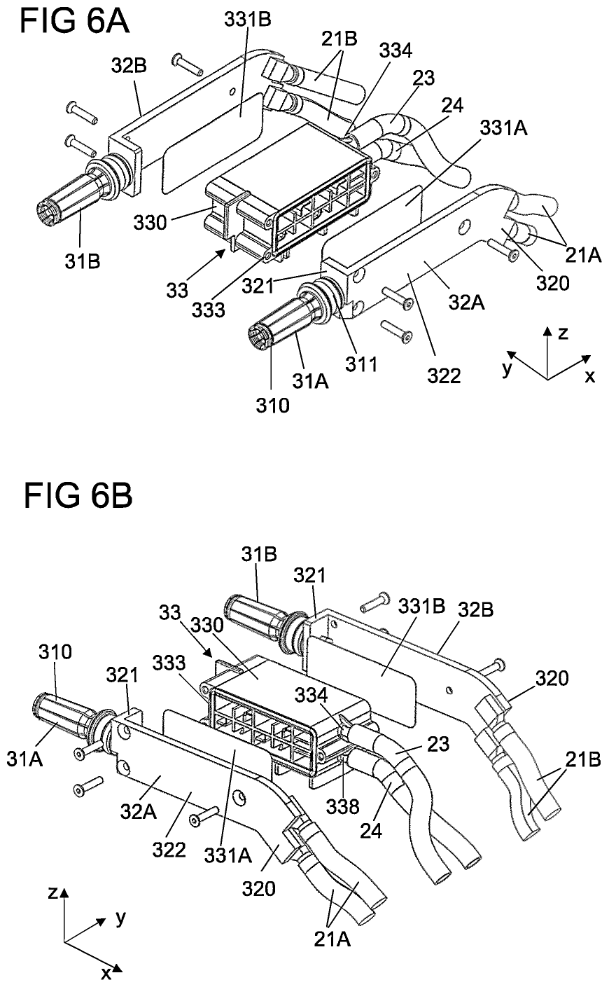

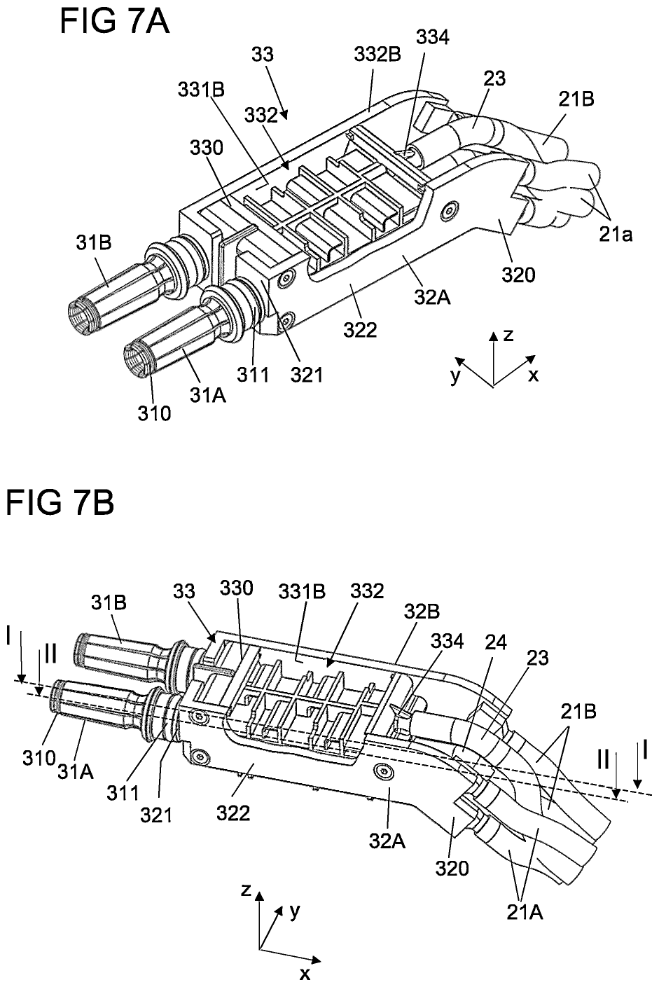

In order to provide cooling, a chamber array 332 is formed in housing 330, as can be seen when considering FIGS. 6A, 6B in conjunction with FIGS. 7A, 7B. Via chamber array 332, a coolant flow can be guided through housing 330 and at face portions 322 of busbars 32A, 32B.

As can be seen from FIGS. 6A, 6B, housing 330 is open at the sides facing the face portions 322 of busbars 32A, 32B, so that housing 330 does not close the chambers formed in housing 30 toward the face portions 322 of busbars 32A, 32B.

However, a separating layer 331A, 331B in the form of, for example, a plastic film made from a polyimide material is disposed between housing 330 and face portions 322 of busbars 32A, 32B on each side, which separating layer 331A, 331B occupies an intermediate position between housing 330 and face portion 322 at the respective side of housing 330, thus separating the chamber array within housing 330 from face portion 322.

Separating layer 331A, 331B is composed of an electrically insulating material. Via separating layer 331A, 331B, the cooling medium inside cooling unit 33 is thus electrically isolated from the respective busbar 32A, 32B. A circumferential seal 333 on each side of housing 330 ensures that coolant cannot escape from the interior of housing 330 and come into electrical contact with the respective busbar 32A, 32B.

Cooling unit 33 has coolant conduits 23, 24 connected thereto, which are routed together with load conductors 21A, 21B within charging cable 2. A first coolant conduit 23 is connected to a first port 334. A second coolant conduit 24 is connected to a vertically offset port 338 on the same side of housing 330 (see in particular FIG. 6B).

The chamber array 332 inside housing 330 is made up of a plurality of chambers which are in fluid communication with each other and which guide a coolant flow through cooling unit 33 between ports 334, 338. The chambers of chamber array 332 are arranged relative to one another so as to produce a meandering coolant flow that is guided back and forth between face portions 322 of busbars 32A, 32B in a meandering manner and, thus, can absorb heat from busbars 32A, 32B.

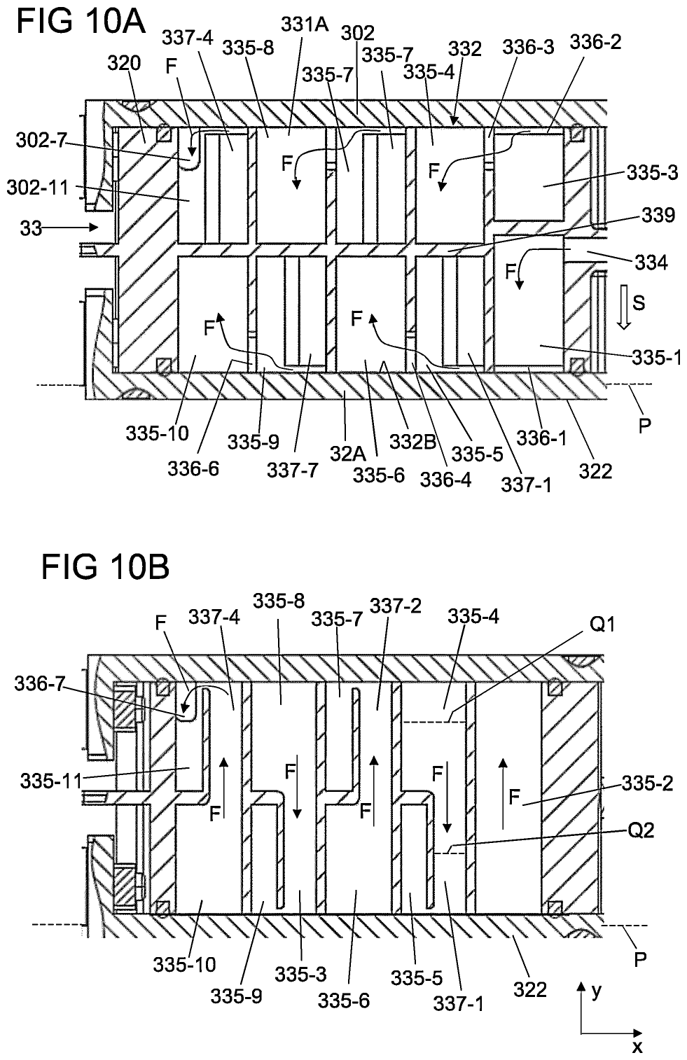

Face portions 322 of busbars 32A, 32B each extend along a plane P defined by a longitudinal direction X and a vertical direction Z (see FIGS. 10A, 10B), the face portions 322 of busbars 32A, 32B extending parallel to each other and being spaced from each other along a transverse direction Y.

In housing 330, two arrays of chambers are formed, which are located at different vertical positions (when viewed along vertical direction Z) and are each associated with one of ports 334, 338. Port 334 serves as an inlet for introducing a coolant flow into the array of chambers located at the level of port 334 (in FIG. 6B, this corresponds to the upper array of chambers within housing 330). Port 338, on the other hand, serves as an outlet for discharging the coolant flow from the array of chambers located at the level of port 338 (in FIG. 6B, this corresponds to the lower array of chambers within housing 330).

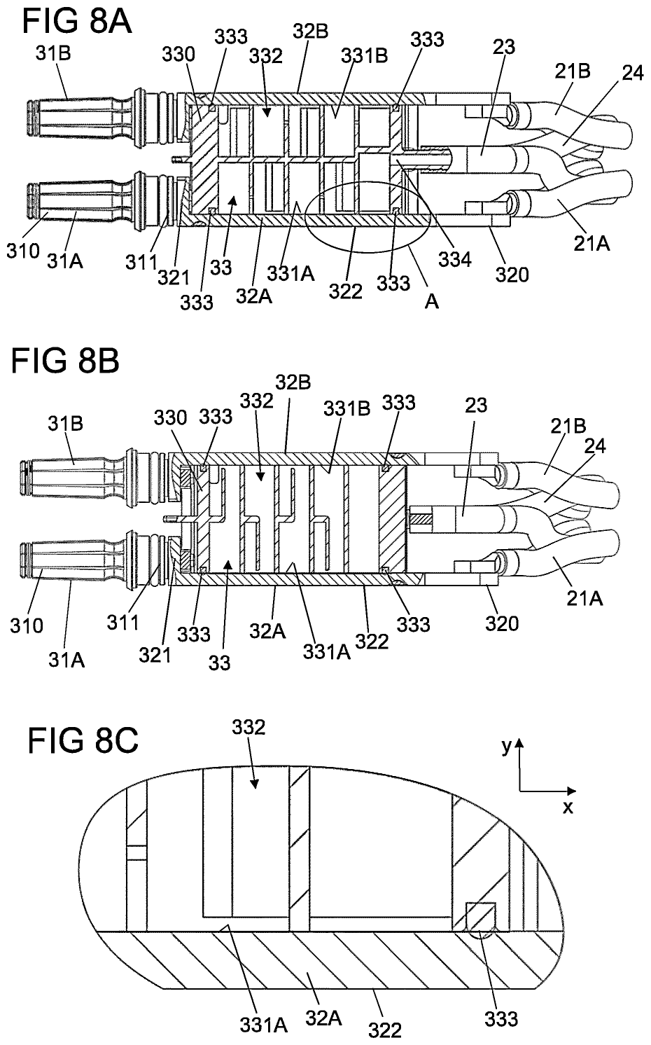

FIGS. 8A and 8B show cross-sectional views taken along lines I-I and II-II in FIG. 7B. These cross-sectional views represent sections through the upper, first array of chambers, which is associated with port 334 and through which a coolant flow flows after it is introduced through port 334, in order to then enter the lower array of chambers and to flow through the lower array of chambers to port 338, and to be discharged through port 338.

From the enlarged representation in FIG. 8C, it can be seen that the chambers of the chamber array 332 are each open toward face portions 322 of busbars 32A, 32B, but are isolated from face portions 322 of busbar 32A, 32B by the respectively associated separating layers 331A, 331B and are thus electrically insulated. At the junction with separating layer 331A, 331B, housing 330 is sealed fluid-tight by circumferential seal 333, so that coolant cannot escape from the interior of housing 330 at the junction with separating layer 331A, 331B.

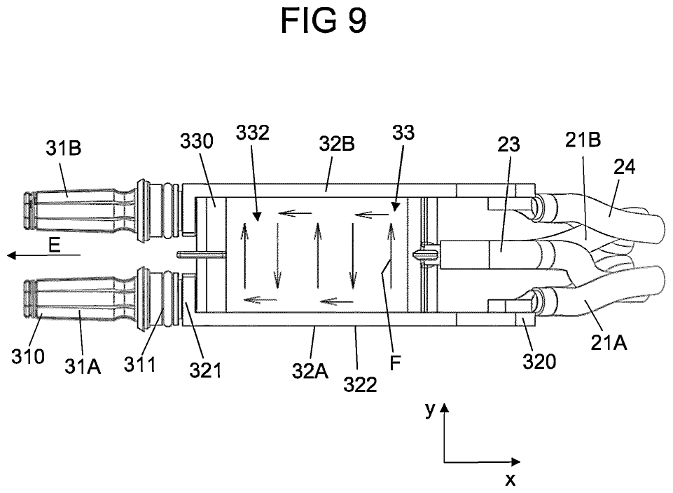

FIG. 9 shows the basic coolant flow F that occurs when the coolant is guided through chamber array 332 within housing 330 of cooling unit 33. In particular, it can be seen that coolant flow F is guided in a meandering manner between face portions 322 of busbars 32A, 32B and is thus alternately guided perpendicularly toward the face portion 322 of one busbar 32A and then perpendicularly toward the face portion 322 of the other busbar 32B. Thus, coolant flow F alternately impinges perpendicularly on one busbar 32A and on the other busbar 32B. By directing the flow toward and onto busbars 32A, 32B in this manner, it is possible to establish a good heat transfer between coolant flow F and face portions 322 of busbars 32A, 32B, and, thus, heat can be efficiently absorbed from busbars 32A, 32B.

Coolant flow F, as schematically shown in FIG. 9, is established by the chambers of chamber array 332 within housing 330. These chambers are in fluid communication with each other and are traversed by the flow one after the other, starting from port 334, the chambers being interconnected and arranged relative to one another so as to produce a meandering coolant flow F, as illustrated in FIG. 9.

Referring now to FIGS. 10A and 10B, coolant flow F first flows from port 334 into a chamber 335-1, in which chamber 335-1 it is directed in a flow direction S toward face portion 322 of busbar 32A (FIG. 10A), which face portion 322 extends flat along a plane P, in order to then pass through a flow passage 336-1 into a chamber 335-2 located therebelow and to flow through chamber 335-2 in the opposite direction to the other busbar 32B (FIG. 10B). At the other busbar 32A, coolant flow F flows through a flow passage 336-2 into a chamber 335-3 located above chamber 335-2 (FIG. 10A) in order to then flow from this chamber 335-3 into a chamber 335-4 that is adjacent thereto along longitudinal direction X.

While chambers 335-1 . . . 335-3 serve to introduce coolant flow F from port 334, a plurality of pairs of chambers 335-4, 335-5; 335-6, 335-7; 335-8, 335-9; 335-10, 335-11 are arranged side-by-side in a row (along longitudinal direction X), which chamber pairs are each arranged and formed mirror-inverted to each other (with respect to a plane of symmetry located centrally between face portions 322 of busbars 32A, 32B) and are in serial flow communication with each other.

From chamber 335-3, coolant flow F flows through a flow passage 336-3 (FIG. 10A) into chamber 335-4 and is guided in chamber 335-4 along flow direction S toward face portion 322 of busbar 32A. At a central wall 339 of housing 330, coolant flow F flows into an approach flow channel 337-1, which adjoins chamber 335-4 in flow direction S and guides coolant flow F with reduced flow cross section perpendicularly onto face portion 322 of busbar 32A, as can be seen from FIG. 10B.

In particular, chamber 335-4 has a flow cross section Q1, which is reduced to a flow cross section Q2 in approach flow channel 337-1. This leads to an increase in flow velocity in approach flow channel 337-1, so that coolant flow F impinges perpendicularly on face portion 322 of busbar 32A at an increased flow velocity.

From approach flow channel 337-1, coolant flow F flows into chamber 335-5, and from chamber 335-5 through a flow passage 336-4 (FIG. 10A) into chamber 335-6, which is adjacent thereto along longitudinal direction X. In chamber 335-6, coolant flow F is then guided toward the other busbar 32B. At central wall 339, coolant flow F flows into an approach flow channel 337-2 adjoining chamber 335-6, which approach flow channel 337-2 in turn guides coolant flow F with reduced flow cross section and at increased flow velocity perpendicularly onto face portion 322 of busbar 32B.

From approach flow channel 337-2, coolant flow F flows into adjoining chamber 335-7 and through flow passage 336-5 into chamber 335-8, which is adjacent thereto along longitudinal direction X and in which coolant flow F is guided toward busbar 32A and through the adjoining approach flow channel 337-3 so as to impinge perpendicularly on busbar 32A. Coolant flow F is then returned to busbar 32B via adjoining chamber 335-9, flow passage 336-6, chamber 335-10, and approach flow channel 337-4.

From approach flow channel 337-4 (FIG. 10A), coolant flow F enters the last chamber 335-11 of the array of chambers at this height plane. At the bottom of this chamber 335-11, there is formed a flow passage 336-7, via which coolant flow F is now guided into the array of chambers located therebelow, in order to flow back in a meandering manner through the chambers of this lower plane and to be discharged through port 338.

Due to the arrangement of chambers 335-1 . . . 335-11, a flow channel is created which guides coolant flow F back and forth between the face portions 322 of busbars 32A, 32B in a meandering manner. Because coolant flow F is alternately guided perpendicularly onto one busbar 32A and onto the other busbar 32B, heat can be efficiently absorbed and removed from busbars 32A, 32B with a good heat transfer coefficient.

In addition, separating layers 331A, 331B between housing 330 and face portions 322 of busbars 32A, 32B provide a reliable electrical insulation between cooling unit 33 and busbars 32A, 32B. Because separating layers 331A, 331B, each formed, for example, by a thin plastic film, can be made thin, separating layers 331A, 331B advantageously do not significantly affect the heat transfer at busbars 32A, 32B.

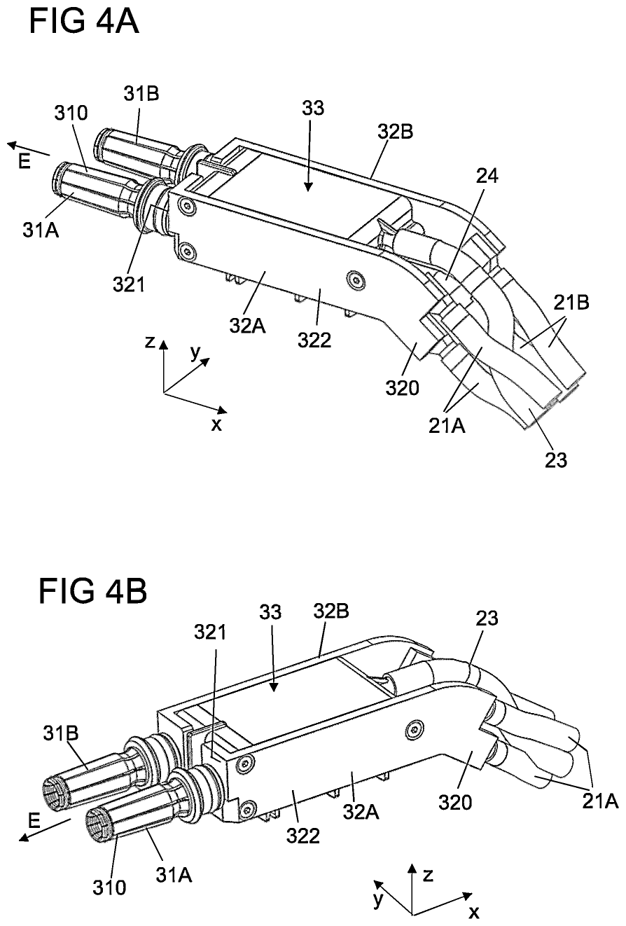

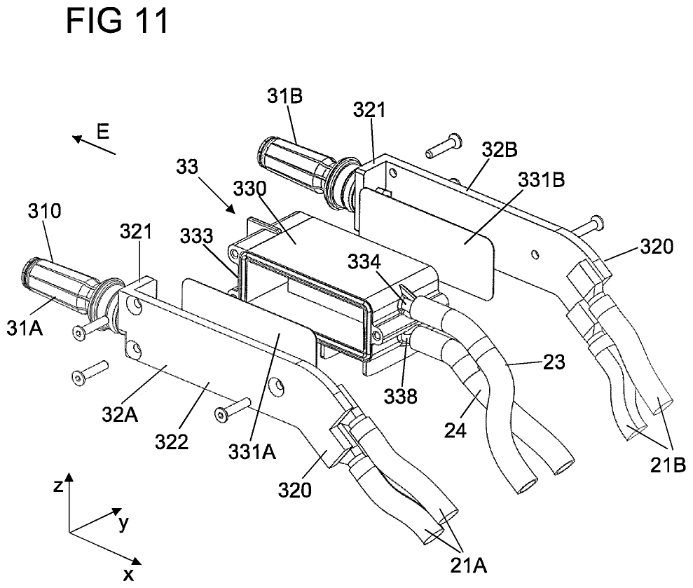

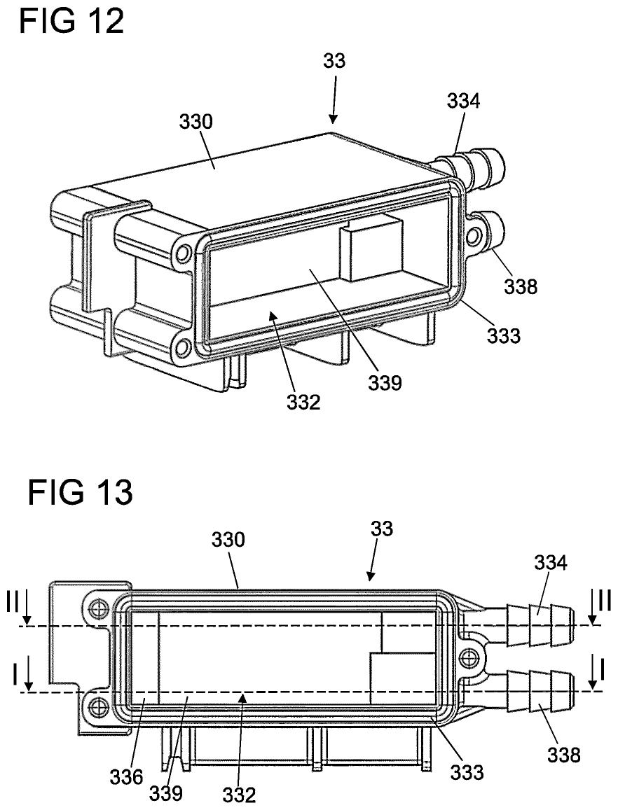

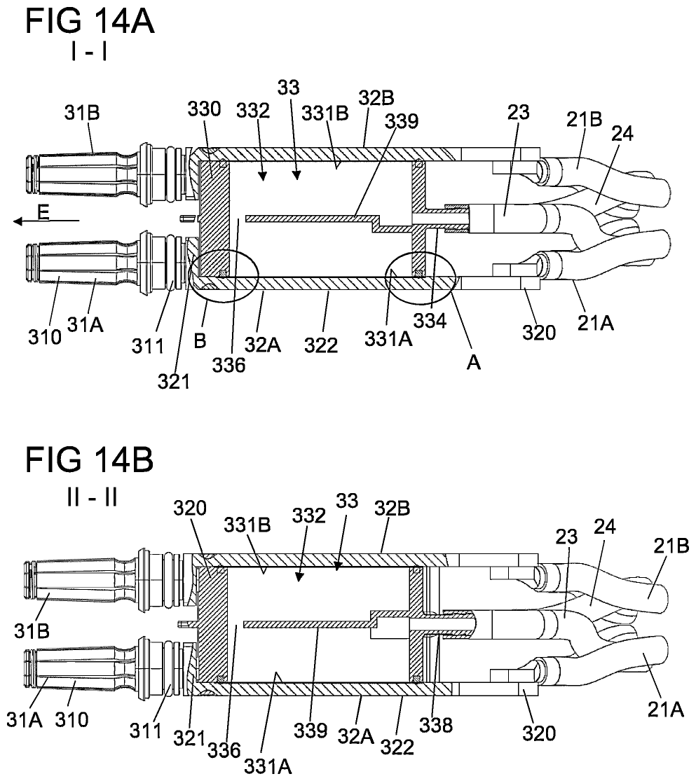

FIGS. 11 through 17 show another exemplary embodiment of a contact assembly of a connector part 3, which has plug contacts 31A, 31B and busbars 32A, 32B with a cooling unit 33 disposed therebetween and in this respect is similar to the contact assembly shown in FIGS. 4A, 4B of the exemplary embodiment described above. The exemplary embodiment of FIGS. 11 through 17 differs only in the design of cooling unit 33. With regard to the other components of connector part 3, reference is therefore made to the above explanations concerning the exemplary embodiment of FIGS. 3A, 3B through 10A, 10B.

In the exemplary embodiment of FIGS. 11 through 17, cooling unit 33 has a housing 330 which forms a chamber array 332 therein which, however is simplified compared to the chamber array 332 of the exemplary embodiment described above and forms only two chambers, which are separated by a central wall 339. A coolant flow is, for example, introduced into one of the chambers via a coolant hose 23 at an inlet 334, flows inside housing 330 through a flow passage 336 into the other, adjacent chamber, and is discharged via an outlet 338 and a coolant hose 24. This results in a coolant flow through housing 330 of cooling unit 33.

As in the exemplary embodiment described above, housing 330 of cooling unit 33 is disposed between face portions 322 of busbars 32A, 32B and is open toward face portions 322. Housing 330 is formed from, for example, a plastic material.

In order to prevent contact with busbars 32A, 32B when using an electrically conductive cooling medium, such as water, a separating layer 331A, 331B is disposed between housing 330 and each face portion 322 of busbars 32A, 32B, which separating layers 331A, 331B electrically insulate, and thus electrically isolate, the interior of housing 330 of cooling unit 33 from the respective busbar 32A, 32B. Separating layer 331A, 331B covers and is in contact with the face portion 322 of the respectively associated busbar 32A, 32B over a continuous surface area thereof. Separating layer 331A, 331B may, for example, be adhesively bonded to the associated face portion 322.

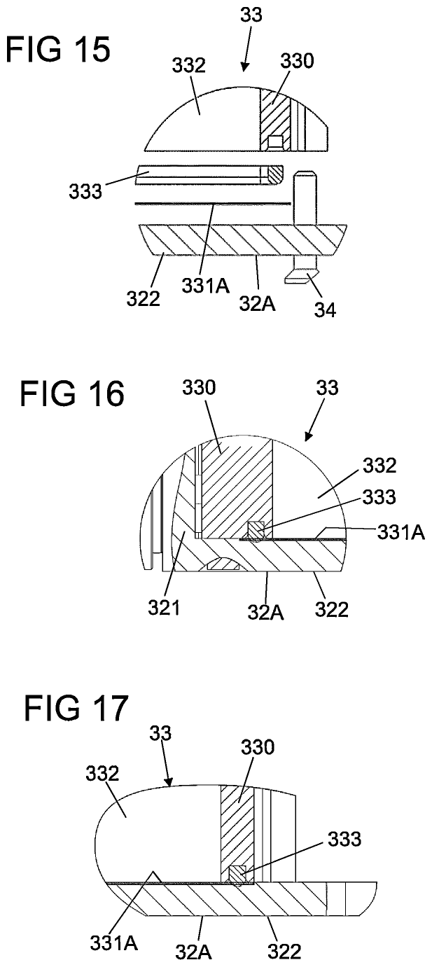

In order to fluid-tightly seal a junction between housing 330 and separating layer 331A, 331B, a seal 333 is disposed at a peripheral edge of housing 330, as can be seen, for example, from the enlarged views of FIGS. 15 through 17. Seal 333 is received on housing 330 and circumferentially surrounds an opening formed in housing 330 and facing the respective busbar 32A, 32B, via which opening housing 330 is open toward the respective busbar 32A, 32B. Seal 333 is in sealing contact with the respectively associated separating layer 331A, 331B, thus sealing a junction between housing 330 and separating layer 331A, 331B in a fluid-tight manner.

Because in the two exemplary embodiments described above, housing 330 is open toward the respectively associated busbar 32A, 32B, the cooling medium flows inside housing 330 directly along separating layer 331A, 331B. The cooling medium flows on one side of separating layer 331A, 331B. The face portion 322 of the respectively associated busbar 32A, 32B is disposed on the other, opposite side of separating layer 331A, 331B, the separating layer 331A, 331B being in contact with and covering face portion 322 over a continuous surface area thereof, so that the cooling medium inside housing 330 of cooling unit 33 is separated from face portion 322 only by separating layer 331A, 331B.

Separating layer 331A, 331B may be made thin and represents a low thermal resistance. At face portion 322, heat can thus pass into the coolant with low thermal resistance and can thus be absorbed and removed by the coolant.

In both exemplary embodiments, separating layer 331A, 331B may be made of, for example, a plastic film, for example of a polyimide material. Such a plastic film may be made very thin, for example with a wall thickness equal to or less than 0.1 mm, preferably equal to or less than 0.07 mm. Such a plastic film may have a high dielectric strength to isolate the electrical potential of the respectively associated busbars 32A, 32B from the coolant. Due to the low thickness of the plastic film, heat can pass efficiently with low heat transfer resistance from busbars 32A, 32B into the coolant.

In another embodiment, insulating layer 331A, 331B may be formed, for example, by a thermally conductive element made from a silicone rubber. Such a thermally conductive element may have a greater thickness than a plastic film made of a polyimide material, for example a thickness equal to or less than 1 mm, preferably equal to or less than 0.5 mm. Such a thermally conductive element can have a high specific thermal conductivity and thus provide a low heat transfer resistance despite its increased wall thickness.

In yet another embodiment, separating layer 331A, 331B may also be formed by an electrically insulating coating, for example in the form of a coat of varnish or a flock coating, on face portion 322.

The concept underlying the invention is not limited to the above exemplary embodiments, but may also be implemented in a different way.

A connector part of the type under discussion may implement a charging plug, for example on a charging cable, or a charging socket, for example on an electric vehicle.

Such a connector part may be used, in particular, for transmitting a charging current in the form of a direct current. However, it is also conceivable that the connector part may be configured for transmitting a charging current in the form of an alternating current.

Active cooling may be provided on one plug contact or on a plurality of plug contacts.

A busbar may be formed as a separate component to a plug contact, but may also be formed integrally with the plug contact, and may thus be implemented by a portion of the plug contact.

The face portion of the busbar may be flat. However, the face portion may also be curved. The separating layer for insulation is accordingly configured to be flat or curved so as to cover the face portion over a continuous surface area thereof.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below. Additionally, statements made herein characterizing the invention refer to an embodiment of the invention and not necessarily all embodiments.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### LIST OF REFERENCE CHARACTERS

1 charging station
2 charging cable
20 cable jacket
200, 201 end
21A, 21B load conductor
22 grounding conductor
23, 24 coolant hose
3 charging plug
30 housing
300, 301 plug-in portion
302, 303 plug-in dome
31A, 31B plug contact
310 contact portion
311 end
32A, 32B busbar
320, 321 end
322 face portion
33 cooling unit
330 housing
331A, 331B separating layer (film)
332 chamber array
333 seal
334 inlet
335-1 . . . 335-11 chamber
336, 336-1 . . . 336-7 flow passage
337-1 . . . 337-4 approach flow channel
338 outlet
339 wall
34 fastening element
4 vehicle
5 charging socket
E insertion direction
F coolant flow
P plane
Q1, Q2 flow cross section
S flow direction
X longitudinal direction
Y transverse direction
Z vertical direction

1. A connector part for a charging system for charging an electric vehicle, the connector part comprising:
a plug-in portion for plugging connection to a mating connector part;
at least one electric plug contact disposed on the plug-in portion and configured to transmit a charging current;
at least one busbar electrically connected to the at least one plug contact, the at least one busbar being connectable to a load conductor, and having a face portion extending flat along a plane; and
a cooling unit having a housing disposed on the face portion and being configured to conduct a coolant flow, the housing being open at a side facing the face portion, an electrically insulating separating layer being disposed between the housing and the face portion, the face portion being disposed on a first side of the separating layer so as to flow the coolant flow on a second side of the separating layer.

2. The connector part of claim 1,
wherein the separating layer comprises a plastic film.

3. The connector part of claim 2,
wherein the plastic film comprises a material containing polyimide.

4. The connector part of 2,
wherein the plastic film has a thickness equal to or less than 0.1 mm.

5. The connector part of claim 1,
wherein the separating layer comprises a thermally conductive element comprising a material different from the material of the housing.

6. The connector part of claim 5,
wherein the thermally conductive element comprises a material comprising silicone rubber.

7. The connector part of claim 5,
wherein the thermally conductive element has a thickness equal to or less than 1 mm.

8. The connector part of claim 1,
wherein the cooling unit comprises a seal disposed between the housing and the separating layer.

9. The connector part of claim 1,
wherein the cooling unit comprises a chamber array arranged in the housing and configured to conduct the coolant flow, the chamber array including a plurality of chambers in fluid communication with one another, at least some of the chambers of the plurality of chambers being configured to guide the coolant flow along a flow direction perpendicular to the plane.

10. The connector part of claim 9,
wherein the chamber array is configured to guide the coolant flow in a meandering manner in the flow direction toward the face portion and away from the face portion against the flow direction.

11. The connector part of claim 9,
wherein a first chamber of the plurality of chambers is configured to guide the coolant flow in the flow direction toward the face portion.

12. The connector part of claim 11,
wherein the first chamber is adjoined by a first approach flow channel configured to guide the coolant flow from the first chamber in the flow direction toward the face portion, the first approach flow channel having a reduced flow cross section compared to a flow cross section of the first chamber.

13. The connector part of claim 11,
wherein a second chamber of the plurality of chambers in fluid communication with the first chamber is configured to guide the coolant flow away from the face portion against the flow direction.

14. The connector part of claim 13,
wherein the second chamber is adjoined by a second approach flow channel configured to guide the coolant flow from the second chamber against the flow direction, the second approach flow channel having a reduced flow cross section compared to a flow cross section of the second chamber.

15. The connector part of claim 13,
wherein a third chamber of the plurality of chambers in fluid communication with the second chamber is configured to guide the coolant flow in the flow direction toward the face portion.

16. The connector part of claim 9,
wherein the plane is defined by a longitudinal direction and a vertical direction and extends perpendicular to a transverse direction, at least some of the chambers of the plurality of chambers being offset from one another along the longitudinal direction and/or along the vertical direction and/or along the transverse direction.

17. The connector part of claim 16,
wherein a first array of chambers of the plurality of chambers is arranged in distributed relation along a first height plane which is perpendicular to the vertical direction, and a second array of chambers of the plurality of chambers is arranged in distributed relation along a second height plane perpendicular to the vertical direction and spaced apart from the first height plane.

18. The connector part of claim 17,
wherein the first array of chambers has a first port configured to introduce the coolant flow, and the second array of chambers has a second port configured to discharge the coolant flow.

19. The connector part of claim 18,
wherein the first port and the second port are each connectable to a coolant hose.

20. The connector part of claim 1,
wherein the at least one electrical plug contact comprises two electrical plug contacts and the at least one busbar comprises two busbars, each busbar of the two busbars having a face portion and each being connected to one plug contact of the two plug contacts, and
wherein the cooling unit is disposed between the face portions of the two busbars.

21. A charging system for charging an electric vehicle, the charging system, comprising:
the connector part of claim 1.
